(19) United States
(12) Patent Application Publication
(10) Pub. No.: US 2015/0199048 A1
(43) Pub. Date: Jul. 16, 2015

(54) TOUCH PANEL ASSEMBLY

(71) Applicant: Carestream Health, Inc., Rochester, NY (US)

(72) Inventors: Robert J. Monson, Roseville, MN (US); Robert R. Brearey, Oakdale, MN (US); Andrew T. Fried, Woodbury, MN (US); Joel T. Abrahamson, Minneapolis, MN (US); Steven W. Tanamachi, Lauderdale, MN (US)

(21) Appl. No.: 14/568,202

(22) Filed: Dec. 12, 2014

Related U.S. Application Data
(60) Provisional application No. 61/927,587, filed on Jan. 15, 2014.

(51) Int. Cl. G06F 3/044

(52) U.S. Cl. CPC G06F 3/044; G06F 2203/04102

(57) ABSTRACT

A touch panel module including a flexible transparent substrate, a transparent conductive film disposed on a first surface of the flexible transparent substrate, a conductive paste disposed on a first portion of the transparent conductive film, an optically clear adhesive disposed on a first and second portion of the conductive paste and a second portion of the transparent conductive film, and a cover lens disposed on the optically clear adhesive, where a third portion of the transparent conductive film and a third portion of the conductive paste are not covered by the optically clear adhesive. A touch panel including such a touch panel module, where the touch panel does not include an anisotropic conductive film.

### CROSS REFERENCE TO RELATED APPLICATIONS

This application claims the benefit of U.S. Provisional Application No. 61/927,587, filed Jan. 15, 2014, entitled “TOUCH PANEL ASSEMBLY,” which is hereby incorporated by reference in its entirety.

### BACKGROUND

Touch panel devices employ an electronic visual display that the user can control through simple or multi-touch gestures. Touch panel devices include game consoles, all-in-one computers, tablet computers, and smartphones. A touch panel configuration may include a flexible printed circuit (FPC) providing connections between the touch panel sensor and the printed circuit board (PCB). On a touch panel sensor, the FPC may be characterized as a “tail” extending from the touch panel sensor. In some cases, the FPC may be a component that is separately formed from the touch panel sensor and later attached to the touch panel sensor.

Touch panels may have a variety of configurations that may be produced through various fabrication methods using various materials. See, for example, U.S. Pat. No. 4,484,038 to Dorman et al., U.S. Pat. No. 4,085,302 to Zenk et al., U.S. Pat. No. 6,819,316 to Schulz et al., U.S. Pat. No. 8,711,113 to Taylor et al., U.S. Pat. No. 6,587,097 to Aufderheide et al., U.S. Pat. No. 7,439,962 to Reynolds et al., and U.S. Pat. No. 8,330,742 to Reynolds et al.

### DESCRIPTION OF FIGURES

FIG. 1A shows a side view of a touch panel module having a touch panel sensor comprising a transparent conductive film (TCF) and FPC.

FIG. 1B shows a top view of the touch panel module of FIG. 1A.

FIG. 2 shows a side view of the touch panel module of Example 1.

FIG. 3 is a photograph of the touch panel of Example 1.

FIG. 4 is a capacitance signal measured upon pressing and releasing a finger applied to the surface of the touch panel of Example 1.

FIG. 5 shows another touch panel according to an embodiment.

FIG. 6 shows a discrete button touch sensor corresponding to the construction of FIG. 5.

FIG. 7 is a photograph of the flexible tail portion of the sensor of FIG. 6.

FIG. 8 shows a backgammon interdigitated electrode touch sensor corresponding to the construction of FIG. 5

FIG. 9 is a photograph of a sheet of 18 touch sensors according to the design of FIG. 8.

FIG. 10 is a photograph of a completed sensor according to the design of FIG. 8.

FIG. 11 is a close-up photograph of the flexible tail portion of the sensor of FIG. 10.

### DESCRIPTION

All publications, patents, and patent documents referred to in this document are incorporated by reference herein in their entirety, as though individually incorporated by reference.

U.S. Provisional Application No. 61/927,587, filed Jan. 15, 2014, entitled “TOUCH PANEL ASSEMBLY,” is hereby incorporated by reference in its entirety.

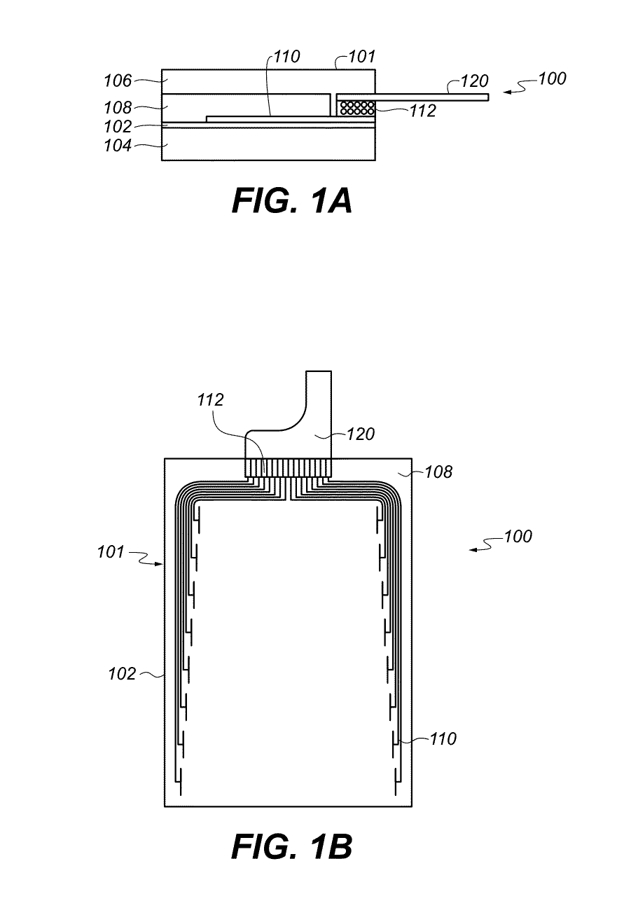

Touch panel modules may have a variety of configurations that may be produced using various fabrication methods. As shown in the side view of FIG. 1A and top view of FIG. 1B, a basic construction of a touch panel module 100 includes a touch panel sensor 101, a printed circuit board (PCB) (not shown), and a flexible printed circuit (FPC) 120 providing connections between the touch panel sensor 101 and the PCB (not shown). At least one connector (e.g. low insertion force (LIF), zero insertion force (ZIF), etc.) may be soldered to the PCB using either surface mount or through hole techniques. Contacts may be provided on the top side, bottom side, or both the top and bottom sides of a connector. The FPC 120 may be inserted into a connector on the PCB (not shown).

The touch panel sensor 101 may comprise a transparent conductive film (TCF) 102 disposed on a substrate 104, a cover lens 106, and an optically clear adhesive (OCA) 108 interposed between the cover lens 106 and the TCF 102. The TCF 102 may comprise conductive structures embedded within a matrix. For example, the TCF 102 may comprise a protective topcoat layer (not shown) disposed on a transparent conductive layer, where the transparent conductive layer comprises conductive structures embedded within a matrix. A conductive paste 110 may be disposed on the TCF 102. The FPC 120 may be a separate component that is bonded to the conductive paste 110 on the TCF 102 using an anisotropic conductive film (ACF) 112. FPCs typically comprise metal traces, such as, for example, copper traces, on a polymeric support, encapsulated with an overcoat. ACFs typically comprise metal coated polymer particles that do not electrically percolate in the XY plane generally parallel to the substrate 104, but do percolate in the Z direction generally normal to the substrate 104 from the TCF 102 and conductive paste 110 to the FPC 120. The OCA 108 may be disposed onto a portion of the TCF 102, such that a portion of the conductive paste 110 is not covered by the OCA 108 and may provide access to bonding with the FPC 120 via ACF 112. In some cases, there may be a hardcoat layer (not shown) disposed on the surface of the substrate 104 opposite of that on which the TCF 102 is disposed. Other layers, such as primer layers or barrier layers, may optionally be disposed between the TCF 102 and the substrate 104.

To further manufacturing cost reductions and efficiency, one approach may be simplifying the design of the touch panels by removing unnecessary materials, components, and assembly time. One potential area of exploration is removal of the FPC and ACF; this has the added benefits of eliminating the necessity of physically registering the FPC contacts with the contacts on the TCF during assembly and elimination of misregistration as a cause of yield losses in manufacture. In some embodiments, expensive raw materials such as silver paste may also be removed from the construction. We have explored several approaches to removing the FPC and ACF while forming a conductive, flexible, and robust tail that can directly connect to the LIF, ZIF, or other connector on the PCB.

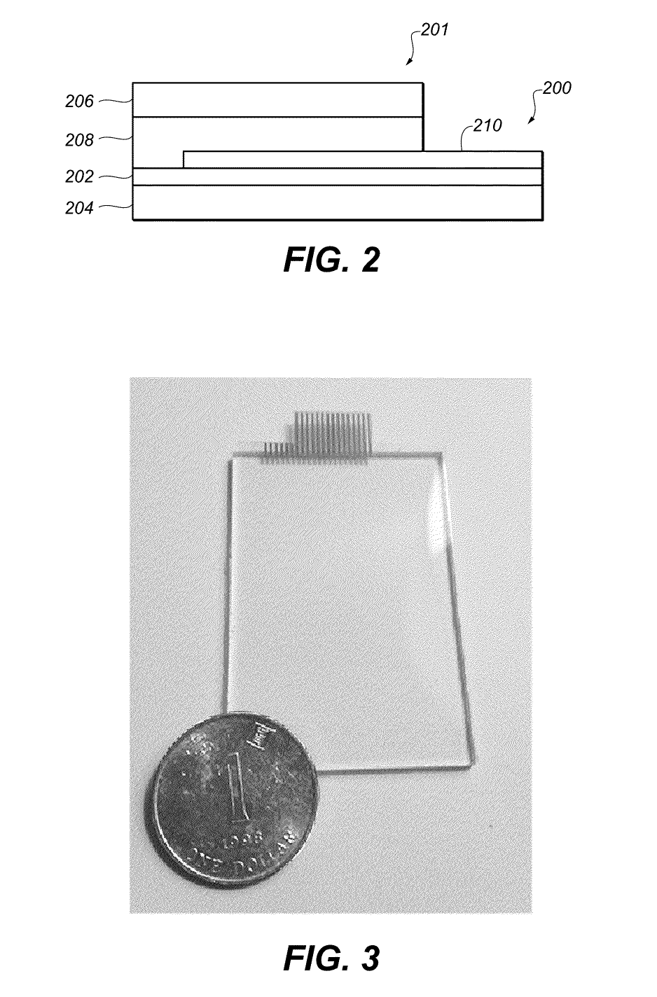

FIG. 2 shows the construction of one such touch panel 200 according to an embodiment. The touch panel sensor 201 comprises a TCF 202 disposed on a substrate 204, a cover lens 206, and an OCA 208 interposed between the cover lens 206 and the TCF 202. The cover lens may be made of a polymeric material, such as, for example, polymethylmethacrylate. In exemplary embodiments, the TCF 202 may comprise a plurality of conductive structures, such as, for example, metal nanowires, metal mesh, or indium tin oxide. Silver nanowires are exemplary conductive structures. In some cases, the conductive nanostructures may be embedded a polymer matrix. Such a polymer matrix may, for example, comprise a cellulose ester polymer, such as, for example, a cellulose acetate polymer, such as, for example, a cellulose acetate butyrate polymer (CAB). A conductive paste 210 may be disposed on the TCF 202.

Note that the cover lens 206 and OCA 208 do not cover the entire extent of the conductive paste 210, the TCF 202, or the substrate 204—these extend out beyond the cover lens and OCA to form a flexible tail that may be connected directly to a connector on the PCB. The portion of the touch panel module under the cover glass is referred to as the “body portion,” while the portion of the touch panel module extending out beyond the cover lens is referred to as the “tail portion.” For the purpose of this application, the body portion may be considered to be “integrally formed” with the tail portion when at least the substrate in the body portion is continuous with the substrate in the tail portion (e.g., formed as an unbroken whole, without interruption, or in a smooth manner), or when the substrate in the body portion and the substrate in the tail portion are formed with a common material and the connection between them has no mechanical joints.

FIG. 3 is a photograph of a functional prototype of this construction, the functionality of which is demonstrated in Example 1. The touch panel design shown in FIG. 3 is actually a grid pattern of buttons, and the traces to the buttons were made in the TCF layer, which comprised silver nanowires.

In the embodiment described above, a very aggressive approach was taken, where even the silver paste around the border of the touch panel was removed and all the traces were routed through the TCF, in this case through the silver nanowires. In practice, this leads to a higher resistance to each sensor so an alternative approach may retain the use of conductive paste screen printed along the border of the touch panel outside the active area. This can be achieved a number of ways, including using silver paste along the border. In addition, carbon loaded silver pastes can reduce cost, or a purely graphite/carbon based paste could be used all along the border. Commercially available carbon pastes can have resistivity down to 10 ohms per square, which is lower than the typical resistivity of TCF materials of 100 or 50 ohms per square.

In some embodiments, the conductive material on the flexible tail of the transparent conductor may be plated with other metals making the exposed material less prone to tarnishing and more robust during insertion and removal from electrical connectors. A plating process such as electroless nickel immersion gold (ENIG) may be used on the conductive areas of the flexible tail, either before patterning or as a post-processing step. Here, it is thought that the nickel acts as a diffusion barrier and the gold prevents corrosion of the conductive pads.

In other embodiments, the conductive material on the flexible tail comprises two or more layers of pastes. For example, a layer of insulative paste, such as, for example, graphite paste, on top of the conductive silver paste can be used to prevent tarnishing of the silver and improve the mechanical reliability during insertion and removal from the connector. For the purposes of this application, a paste is “insulative” if it is less conductive than the conductive paste over which it is disposed. In some cases, the graphite based paste can be printed slightly wider than the silver paste so that the silver paste is completely enclosed by carbon. Without wishing to be bound by theory, it is believed that carbon paste can inhibit dendrite growth on silver, also known as silver migration. In some embodiments, the carbon paste will only need to be superimposed on the silver paste along the exposed area of conductive trace between the OCA and the connector on the PCB.

Graphite pastes are significantly less expensive than silver pastes; however, they also tend to exhibit higher resistance. In another embodiment, a paste comprising a mixture of silver and graphite could be used along the border of the touch panel outside the active area. Yet another embodiment may use a 100% graphite loaded conductive paste, both along the border of the touch panel beneath the OCA but outside the active area and also in the exposed area in contact with the environment.

In still another embodiment, various other commercially available conductive pastes may be used, such as, for example, silver, copper, or carbon loaded epoxies. Conductive and insulative pastes may generally include other components, such as, for example, polymeric binders.

In some embodiments, various protective films or coatings may be applied on top of the exposed conductor on the tail. For example, a simple tape such as KAPTON tape or a cover layer laminated over the conductive traces could help protect the screen printed traces in case, in the assembly of the system, the flexible tail is bent around other objects to connect to the PCB. In the event of a bending or forming process with the tail, the protective film over the traces would also move the neutral axis of strain closer to the Z-height of the conductive traces reducing the risk that the traces might crack or become damaged. Various other dielectric materials are commercially available such as underfills, conformal coatings, and similar. Furthermore, encapsulant materials such as silicone based conformal coatings or parylene conformal coatings could prevent oxidation of screen printed conductive pastes. These conformal coatings can be spray coated, syringe dispensed, or applied in other ways. Typically areas that are undesired to have the coating are masked off—in this case, one area would be where the conductive pads get inserted into the connector.

In an exemplary embodiment as shown in FIG. 2, the tail portion replaces the separate component FPC and the ACF that is used to bond the FPC with the TCF. The tail portion may be supplemented with at least one stiffener that increases the rigidity of the tail portion. In some embodiments, the stiffener may be a material that is disposed on the tail portion. For example, the stiffener may be laminated to the tail portion. In some embodiments, the stiffener may be a composition added to the tail portion during the coating process. In some embodiments, the stiffener may be applied in such a manner so as to increase the thickness of the tail portion so the tail portion is compatible for connection with commercial connectors. The stiffener may provide strain relief. Strain relief may reduce flexibility, which improves ease and reliability of connection between the tail portion and the PCB, and reduce bending curvature due to the weight of the electronic components or force caused when connecting with the PCB. The stiffener may also provide greater flatness or stability for mechanical manipulation during assembly or connection. A variety of types of materials can be used as a stiffener, such as, for example, the polymers polyethylene terephthalate (PET), polyimide, polystyrene, polyvinylchloride (PVC), or combinations thereof.

The stiffener may be disposed on at least a part of the tail portion. In some embodiments, the stiffener may be disposed on an entire surface of the tail portion. In some embodiments, the stiffener may be disposed on part of the surface of the tail portion. The stiffener may be disposed on the end part of the tail portion for improved connection with the PCB. In this application, the end part of the tail portion is further away from the junction at which the body portion and tail portion meet. One or more stiffeners may be disposed on the tail portion. Where at least two stiffeners are used, the stiffeners may be disposed on different parts or regions of the tail portion.

In an exemplary embodiment, one or more conductive compounds are applied to the TCF. The conductive compound may be a metallic compound, such as, for example, silver ink or silver paste. The conductive compound may be applied through various methods, such as, for example, screen printing or stencil printing. One or more insulative compounds may be disposed on the conductive compound near or at the region where the tail portion inserts into or makes contact with a connector (e.g. ZIF or LIF). The insulative compound may, for example, be a carbon ink or a carbon paste.

Certain regions of the TCF may be patterned to render those regions less conductive. Patterning may be accomplished through various methods, such as laser patterning or chemical etching (e.g. screen printed mask, screen printed etching, or photolithography). For example, parts of the TCF in the body portion may be patterned, or parts of the TCF in the tail portion may be patterned, or both. In some embodiments, the overlapped conductive compound and insulative compound may be ablated (not shown in FIG. 3). A UV curable dielectric layer may be disposed on the tail portion.

The OCA may be attached to the TCF through various means, such as lamination, exposure to a carbon dioxide laser, and autoclaving. A cover lens may be attached to the touch panel sensor through various means, such as lamination, and autoclaved.

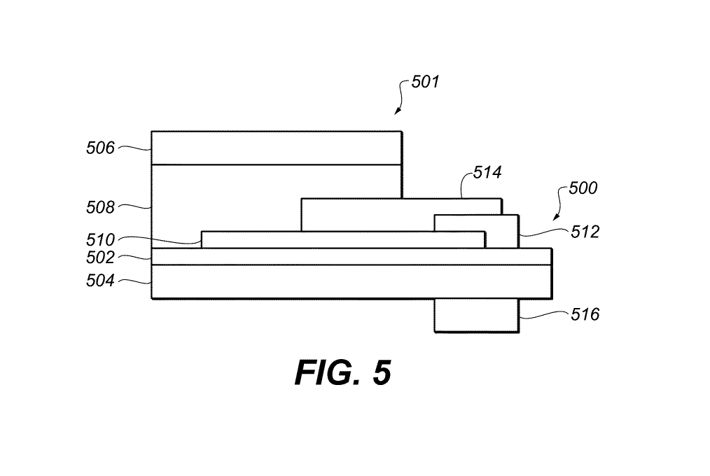

FIG. 5 shows the construction of another touch panel 500 according to an embodiment. The touch panel sensor 501 comprises a TCF 502 disposed on a surface of flexible substrate 504. In some cases, the TCF 502 may comprise a protective topcoat layer (not shown) disposed on a transparent conductive layer. In some cases, a hardcoat layer (not shown) may be disposed on the surface of flexible substrate 504 opposite to that on which the TCF is disposed. A stiffener 516 is disposed on the tail portion of the flexible substrate 504 on the surface of flexible substrate 504 opposite to that on which TCF 502 is disposed. If a hardcoat layer (not shown) is present, the stiffener 516 is preferably disposed in a similar position on the hardcoat layer. A conductive paste 510 is disposed on at least a portion of the TCF 502, extending from at least a portion of the body portion of the touch panel to the tail portion. Insulative paste 512 is disposed on at least a portion of the conductive paste 510 in the tail portion and may also be disposed on at least a portion of the TCF 502 in the tail portion. Dielectric 514 is disposed on a portion of the conductive paste 510 and insulative paste 512, extending from the body portion of the touch panel to the tail portion. OCA 508 is disposed on the portions of TCF 502 in the body portion of the touch panel that are not covered with conductive paste. OCA 508 is also disposed on the portions of conductive paste 510 that are not covered by the dielectric 514. OCA 508 is also disposed on the portions of dielectric 514 that are in the body portion. Cover lens 506 is disposed on OCA 508. Other layers, such as primer layers or barrier layers, may optionally be disposed between the TCF 502 and flexible substrate 504.

### Exemplary Embodiments

Here follow 20 non-limiting exemplary embodiments:

A. A touch panel module comprising:

a flexible transparent substrate,

a transparent conductive film disposed on a first surface of the flexible transparent substrate,

a conductive paste disposed on a first portion of the transparent conductive film,

an optically clear adhesive disposed on a first and second portion of the conductive paste and a second portion of the transparent conductive film, and

a cover lens disposed on the optically clear adhesive,

wherein a third portion of the transparent conductive film and a third portion of the conductive paste are not covered by the optically clear adhesive.

B. The touch panel module according to embodiment A, further comprising:

an insulative paste disposed on the third portion of conductive paste and the third portion of the transparent conductive film.

C. The touch panel module according to embodiment B, wherein the insulative paste comprises carbon.
D. The touch panel module according to either of embodiments B or C, further comprising:

a first portion of dielectric disposed in between the optically clear adhesive and the second portion of transparent conductive film, and

a second portion of dielectric disposed on at least a portion of the insulative paste.

E. The touch panel module according to any of embodiments A-D, further comprising a stiffener disposed on a second surface of the transparent flexible substrate, the second surface being opposed to the first surface.
F. The touch panel module according to any of embodiments A-E, wherein the transparent conductive film comprises at least one transparent conductive layer.
G. The touch panel module according to embodiment F, wherein the at least one transparent conductive layer comprises a plurality of conductive structures embedded in a matrix.
H. The touch panel module according to embodiment G, wherein the plurality of conductive structures comprises metal nanowires.
J. The touch panel module according to embodiment G, wherein the plurality of conductive structures comprises metal mesh.
K. The touch panel module according to embodiment G, wherein the plurality of conductive structures comprises indium tin oxide.
L. The touch panel module according to embodiment G, wherein the plurality of conductive structures comprises silver nanowires.
M. The touch panel module according to any of embodiments G-L, wherein the matrix comprises at least one polymer.
N. The touch panel module according to embodiment M, wherein the at least one polymer comprises a cellulose ester polymer.
P. The touch panel module according to embodiment M, wherein the at least one polymer comprises a cellulose acetate polymer.
Q. The touch panel module according to embodiment M, wherein the at least one polymer comprises cellulose acetate butyrate.
R. The touch panel module according to any of embodiments A-Q, wherein the conductive paste comprises silver.
S. The touch panel module according to embodiment R, wherein the conductive paste further comprises carbon.
T. The touch panel module according to any of embodiments A-Q, wherein the conductive paste comprises carbon.
U. A touch panel comprising the touch panel module according to any of embodiments A-T, wherein the touch panel does not comprise an anisotropic conductive film.
V. The touch panel according to embodiment U, further wherein the touch panel does not comprise a flexible printed circuit.

### EXAMPLES

### Example 1

A touch panel was fabricated according to the construction illustrated in FIG. 2. A photograph of the completed touch panel is shown in FIG. 3.

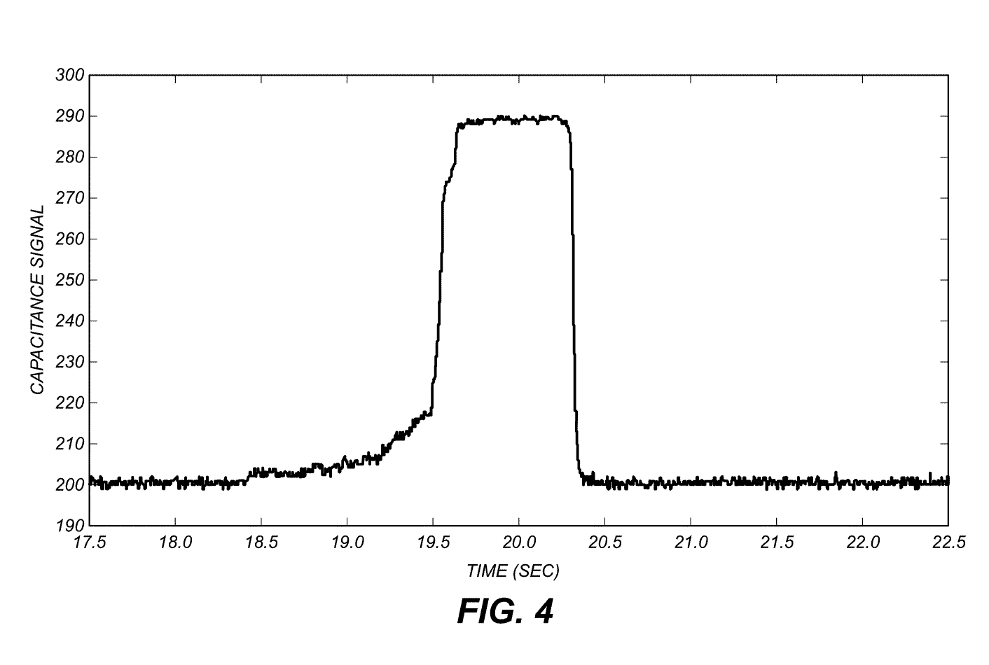

This touch panel was etched with a grid pattern of buttons and connected to circuitry that enabled detection of changes in the touch panel's capacitance. FIG. 4 shows the change in capacitance signal as a finger presses and releases a button. The measured signal to noise ratio was over 20.

### Example 2

A touch panel was fabricated according to the construction illustrated in FIG. 5. FLEXX 100 brand silver nanowire based transparent conductive film (nominally 100 ohm/sq surface resistivity, available from Carestream Health, Inc.) was used as the TCF and substrate. Silver containing paste was used as the conductive paste. Carbon containing paste was used as the insulative paste, being disposed over the conductive paste on the end that can be directly inserted into a ZIF connector. UV curable dielectric was also disposed over the conductive and insulative pastes, while also extending under the OCA. This dielectric overprint provided mechanical flexibility and scratch resistance, so that the tail portion could be bent and twisted during manufacturing and assembly of the next larger system. In order to ensure a proper tail thickness for connection with the ZIF, the underside of the tail portion contained a polyethylene terephthalate stiffener, which brought the total thickness of the tail to approximately 0.3 mm.

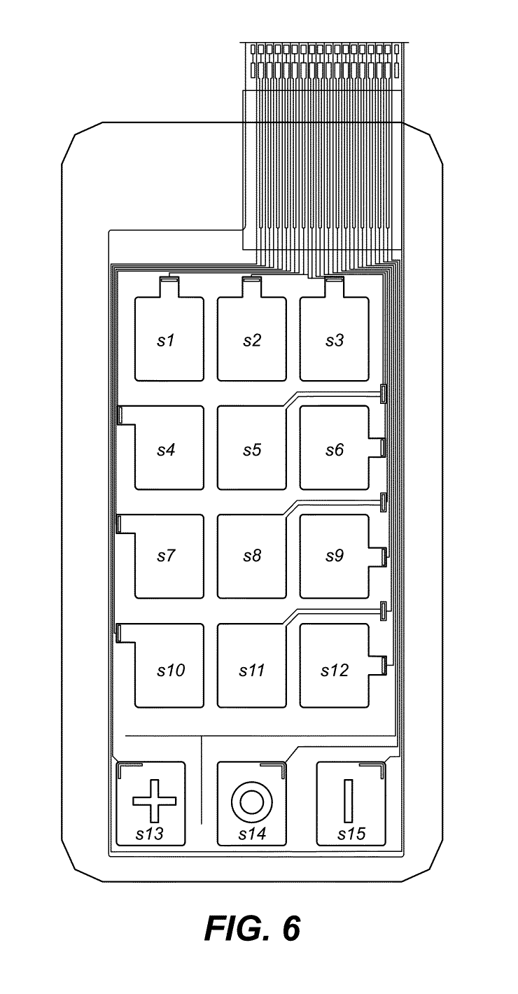

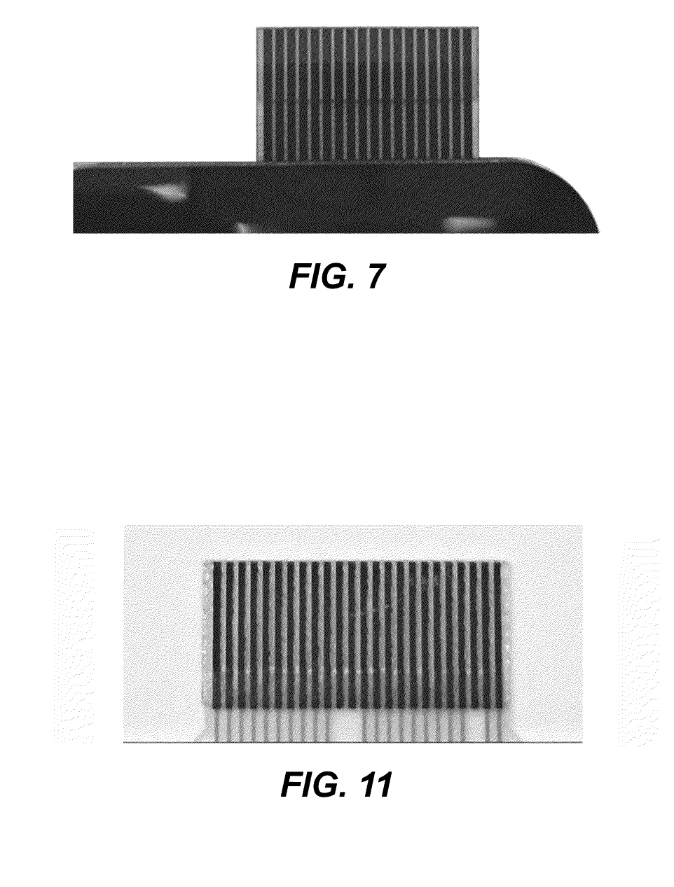

A discrete button touch pad was etched in the active portion of the touch sensor, as shown in FIG. 6. A photograph of the tail portion is shown in FIG. 7. Several of the resulting discrete button touch sensors were tested using a CYPRESS programmable system on a chip (PSoC) touch controller and the design functioned as intended.

### Example 3

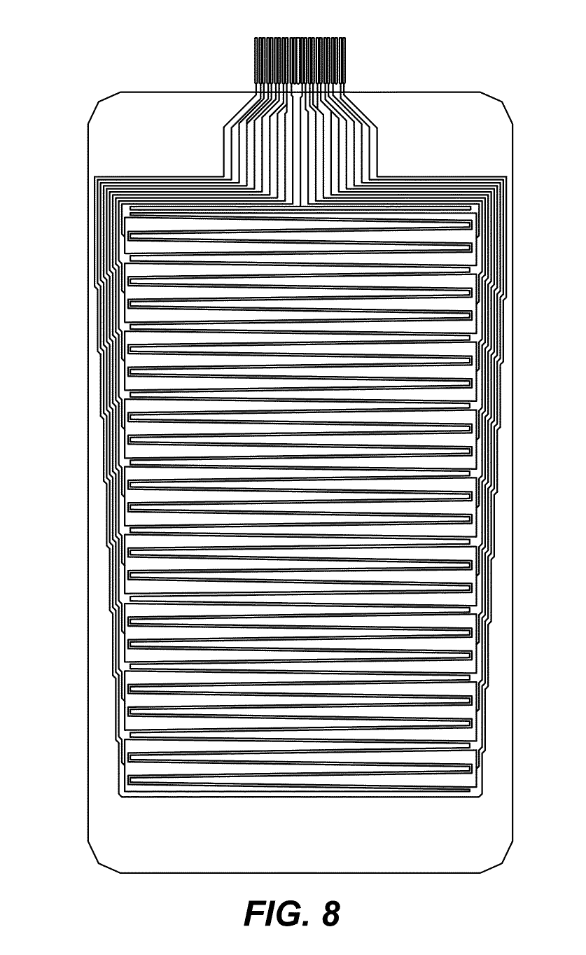

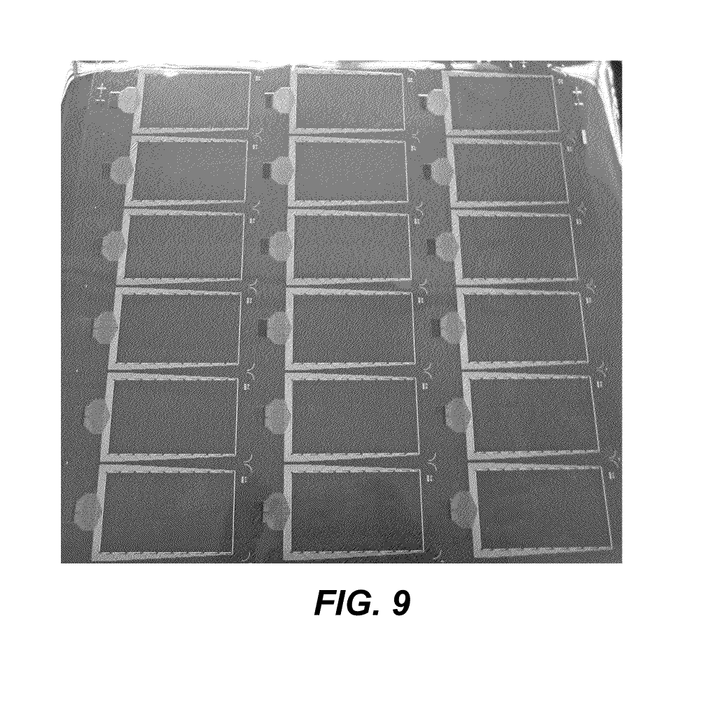

A touch panel was fabricated according to the construction illustrated in FIG. 5, similar to that described in Example 2. The FLEXX 100 brand film was sheeted, screen printed on the backside with a protective mask, which was cured. The film was annealed at 150-160° C. for 30 minutes. The silver paste was screen printed on the active side of the FLEXX 100 film, then cured. The carbon paste was screen printed thereon and cured. The active area of FLEXX 100 brand film was laser patterned to form a “backgammon design” of interdigitated electrodes, as shown in FIG. 8. This design can interpolate an XY coordinate position for single touches and limited multi-touches. The area in between the screen printed silver paste traces was also laser patterned. Laser ablation of the silver paste was used to define fine traces. The UV cure dielectric was screen printed thereon and cured. FIG. 9 shows a sheet of 18 touch sensors during manufacturing. The OCA was then cut to the correct dimensions and laminated over the active side of the FLEXX 100 brand film, according to the construction of FIG. 5. The individual sensors were singulated with CO₂ laser or die-punch systems. Cover lenses were laminated over the OCA on each individual sensor and autoclaved.

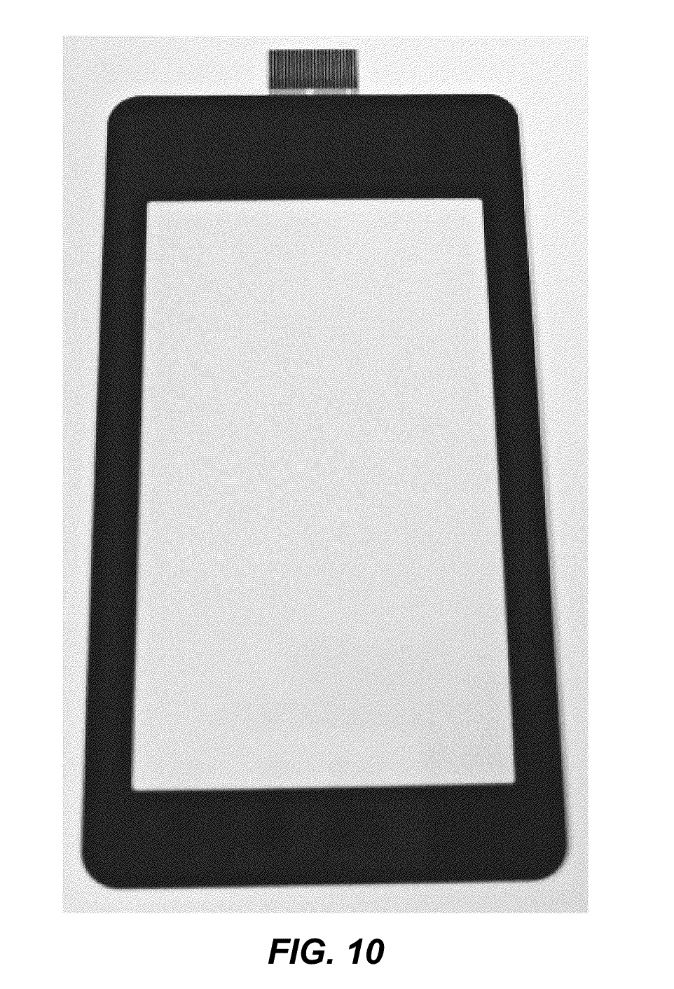

A photograph of the competed sensor is shown in FIG. 10. A close-up photograph of the tail portion is shown in FIG. 11, with the carbon paste appearing in black, the dielectric appearing in green, and the silver paste appearing in grey. These touch panels were tested with control circuitry and functioned as intended.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims, and all changes that come within the meaning and range of equivalents thereof are intended to be embraced therein.

What is claimed:

1. A touch panel module comprising:
a flexible transparent substrate,
a transparent conductive film disposed on a first surface of the flexible transparent substrate,
a conductive paste disposed on a first portion of the transparent conductive film,
an optically clear adhesive disposed on a first and second portion of the conductive paste and a second portion of the transparent conductive film, and
a cover lens disposed on the optically clear adhesive,
wherein a third portion of the transparent conductive film and a third portion of the conductive paste are not covered by the optically clear adhesive.

2. The touch panel module according to claim 1, further comprising:
an insulative paste disposed on the third portion of conductive paste and the third portion of the transparent conductive film.

3. The touch panel module according to claim 2, wherein the insulative paste comprises carbon.

4. The touch panel module according to claim 2, further comprising:
a first portion of dielectric disposed in between the optically clear adhesive and the second portion of transparent conductive film, and
a second portion of dielectric disposed on at least a portion of the insulative paste.

5. The touch panel module according to claim 1, further comprising a stiffener disposed on a second surface of the transparent flexible substrate, the second surface being opposed to the first surface.

6. The touch panel module according to claim 1, wherein the transparent conductive film comprises at least one transparent conductive layer.

7. The touch panel module according to claim 6, wherein the at least one transparent conductive layer comprises a plurality of conductive structures embedded in a matrix.

8. The touch panel module according to claim 7, wherein the plurality of conductive structures comprises metal nanowires.

9. The touch panel module according to claim 7, wherein the plurality of conductive structures comprises metal mesh.

10. The touch panel module according to claim 7, wherein the plurality of conductive structures comprises indium tin oxide.

11. The touch panel module according to claim 7, wherein the plurality of conductive structures comprises silver nanowires.

12. The touch panel module according to claim 1, wherein the matrix comprises at least one polymer.

13. The touch panel module according to claim 12, wherein the at least one polymer comprises a cellulose ester polymer.

14. The touch panel module according to claim 12, wherein the at least one polymer comprises a cellulose acetate polymer.

15. The touch panel module according to claim 12, wherein the at least one polymer comprises cellulose acetate butyrate.

16. The touch panel module according to any of claim 1 wherein the conductive paste comprises silver.

17. The touch panel module according to claim 16, wherein the conductive paste further comprises carbon.

18. The touch panel module according to any of claim 1 wherein the conductive paste comprises carbon.

19. A touch panel comprising the touch panel module according to claim 1, wherein the touch panel does not comprise an anisotropic conductive film.

20. The touch panel according to claim 19, further wherein the touch panel does not comprise a flexible printed circuit.
